(19) United States
(12) Patent Application Publication
(10) Pub. No.: US 2015/0314409 A1
(43) Pub. Date: Nov. 5, 2015

(54) PROTECTIVE APPARATUS FOR A MACHINE TOOL

(71) Applicant: Chih-Hui Chiu, Yilan County (TW)

(72) Inventor: Chih-Hui Chiu, Yilan County (TW)

(21) Appl. No.: 14/700,600

(22) Filed: Apr. 30, 2015

(30) Foreign Application Priority Data
May 2, 2014 (TW) 103115877

(51) Int. Cl. B23Q 5/58; B23B 39/00; B27G 19/04

(52) U.S. Cl. CPC B23Q 5/58; B27G 19/04; B23B 39/00; B23B 2260/122; B23B 2260/128

(57) ABSTRACT

A protective apparatus and a machine tool are provided. The machine tool includes an operational element, a driving element, and the protective apparatus. The operational element and the driving element are disposed on machine table. The protective apparatus includes an insulating unit, conducting unit, capacitance sensor, and control unit. The insulating unit is disposed between the operational element and the driving element. The driving element drives the operational element by the insulating unit. The conducting unit contacts the operational element. The capacitance sensor electrically connects the conducting unit for sensing capacitance of the conducting unit. The control unit electrically connects the capacitance sensor and the driving element and determines whether a user approaches the operational element based on the capacitance. When the control unit detects that the distance between the user and the operational element is too close, the control unit stops the operation of the operational element.

### BACKGROUND

1. Technical Field

The present disclosure relates to a protective apparatus for a machine tool, in particular, to a protective apparatus for a machine tool for preventing an operational element of the machine tool in operation from harming the user.

2. Description of Related Art

In cutting tools, the machine tool is one that easily can cut the user in operation, especially the machine tool for cutting wood. Either the professional technician or the do-it-yourself person easily gets hurt by using the machine tool. In order to increase the safety of using the machine tool, the traditional machine tool is configured with the protective apparatus.

Regarding the protective apparatus of the machine tool, one method is a clear shield installed around the machine tool to avoid the distance between the user and a saw blade configured in the machine tool getting too close. Another method is a security sensor installed around the machine tool to stop the operation of the machine tool when the distance between the user and the saw blade configured in the machine tool gets too close. However, the security sensor has many blind spots for sensing, causing safety problems for the user because of the sensing failure. Therefore, the method of installing the security sensor around the machine tool easily causes the industrial safety problem.

### SUMMARY

An exemplary embodiment of the present disclosure provides a protective apparatus, and which is adapted for a machine tool. The machine tool has a driving element and an operational element. The driving element is used for driving the operational element. The protective apparatus includes an insulating unit, a conducting unit, a capacitance sensor, and a control unit. The insulating unit is configured between the operational element and the driving element, so that the driving element drives the operational element through the insulating unit. The conducting unit contacts the operational element. The capacitance sensor is electrically connected to the conducting unit and used for sensing a capacitance of the conducting unit. The control unit is electrically connected to the capacitance sensor and the driving element. When the capacitance sensor determines that the capacitance is more than a predefined value, the capacitance sensor generates a stop signal to the control unit, and the control unit controls the driving element to stop driving the operational element according to the stop signal.

An exemplary embodiment of the present disclosure provides a machine tool. The machine tool includes an operational element, a driving element, and a protective apparatus. The operational element is configured to a machine table. The driving element is configured to the machine table. The protective apparatus includes an insulating unit, a conducting unit, a capacitance sensor, and a control unit. The insulating unit is configured between the operational element and the driving element, so that the driving element drives the operational element through the insulating unit. The conducting unit contacts the operational element. The capacitance sensor is electrically connected to the conducting unit and used for sensing a capacitance of the conducting unit. The control unit is electrically connected to the capacitance sensor and the driving element. When the capacitance sensor determines that the capacitance is more than a predefined value, the capacitance sensor generates a stop signal to the control unit, and the control unit controls the driving element to stop driving the operational element according to the stop signal.

To sum up, the exemplary embodiments of the present disclosure provide a protective apparatus and a machine tool, which can avoid that a capacitance sensor has blind spots for sensing, to enhance the security for the user using the machine tool.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is an explosion diagram of a machine tool according to an exemplary embodiment of the present disclosure.

FIG. 1B is a structural diagram of a machine tool according to an exemplary embodiment of the present disclosure.

FIG. 1C is a diagram of user operating a machine tool to cut wood according to an exemplary embodiment of the present disclosure.

FIG. 1D is a circuit diagram of a capacitance sensor according to an exemplary embodiment of the present disclosure.

FIG. 2 is an explosion diagram of a machine tool according to another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

The present disclosure provides a protective apparatus and a machine tool. In the protective apparatus and the machine tool of the present disclosure, a conducting unit and an operational element are electrically connected with each other, so that a capacitance sensor can detect whether a user approaches the operational element. When the capacitance sensor detects that the distance between the user and the operational element is too close, the protective apparatus stops the operation of the operational element. Compared with the security sensor installed around the machine tool, the capacitance sensor of the present disclosure does not have the blind spot problem for sensing because the capacitance sensor electrically connects to the operational element through the conducting unit. Therefore, when the user uses the machine tool, it can reduce the probability of harm.

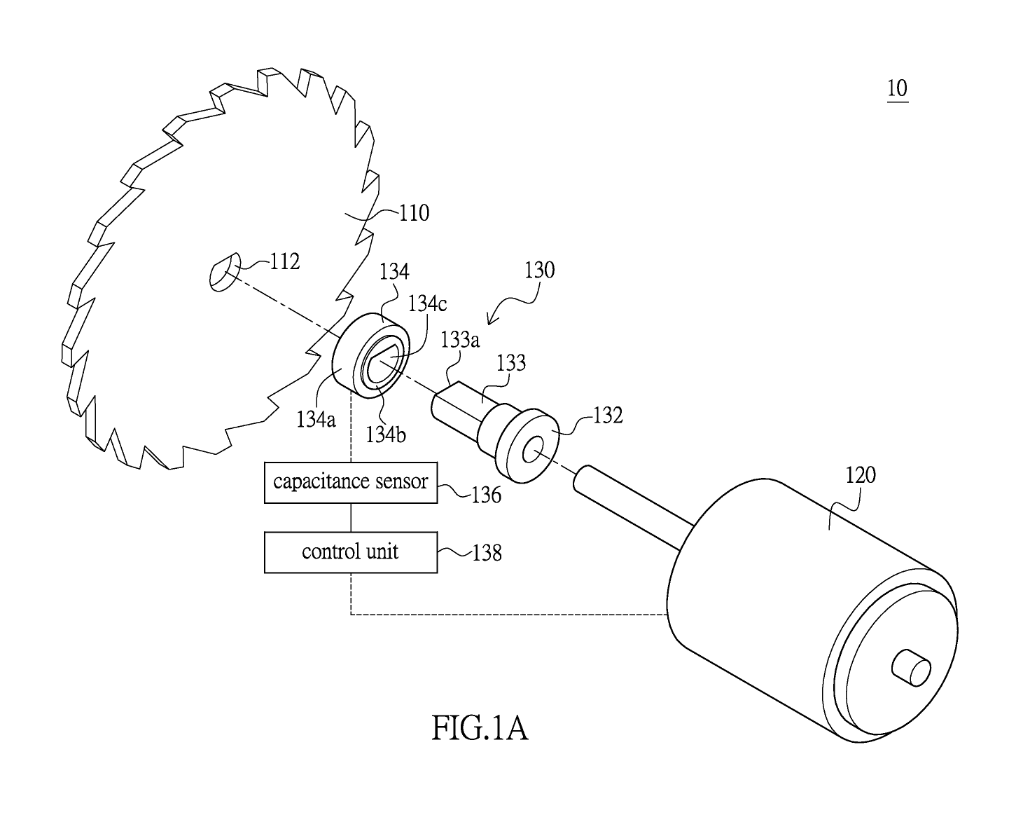

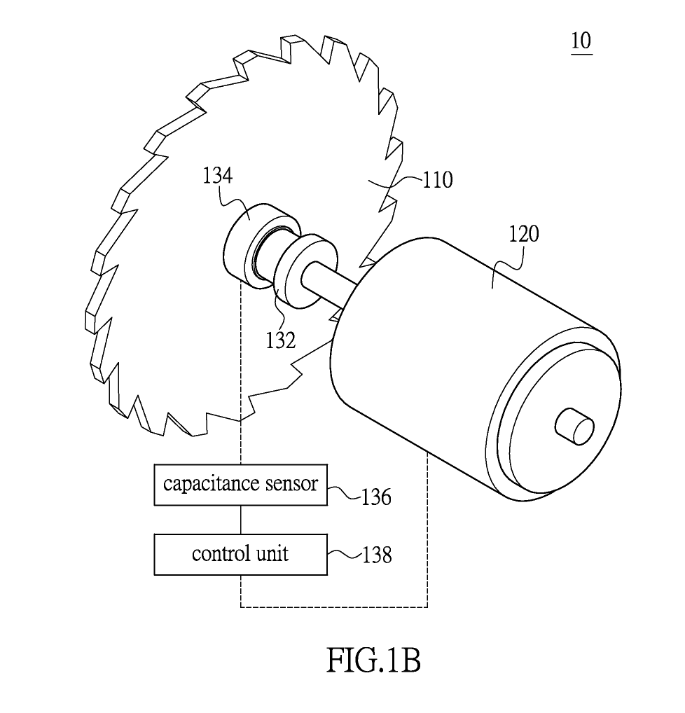

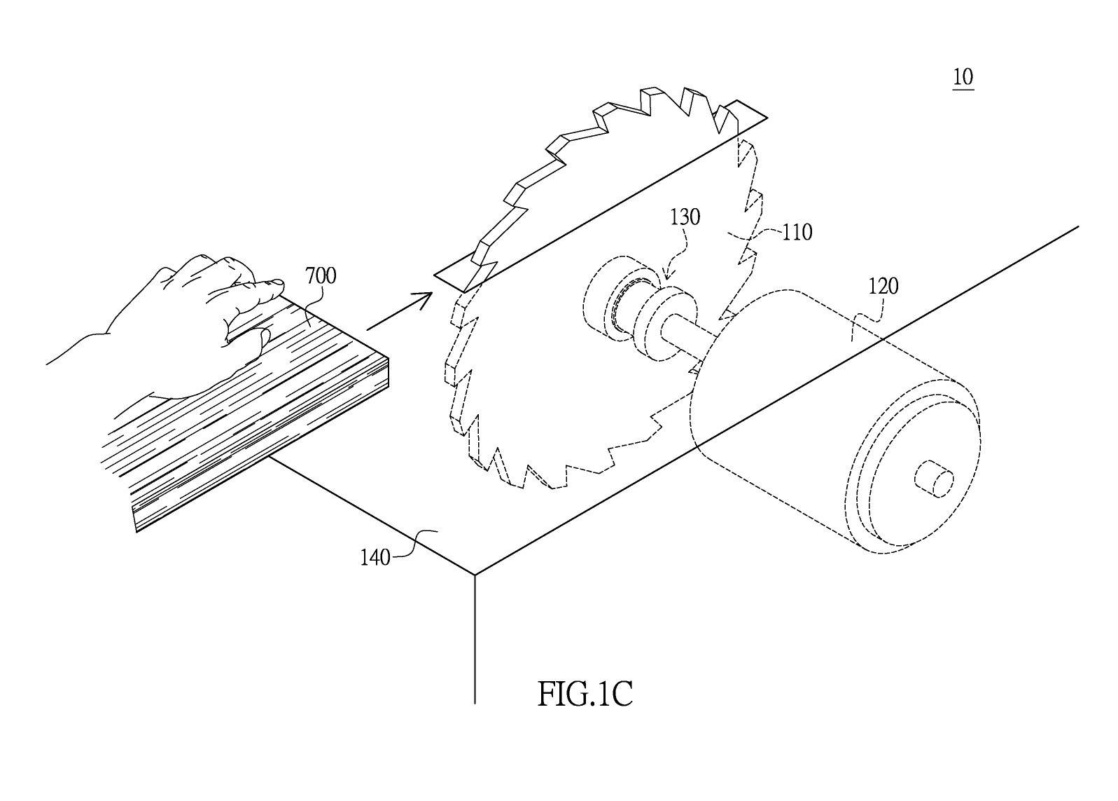

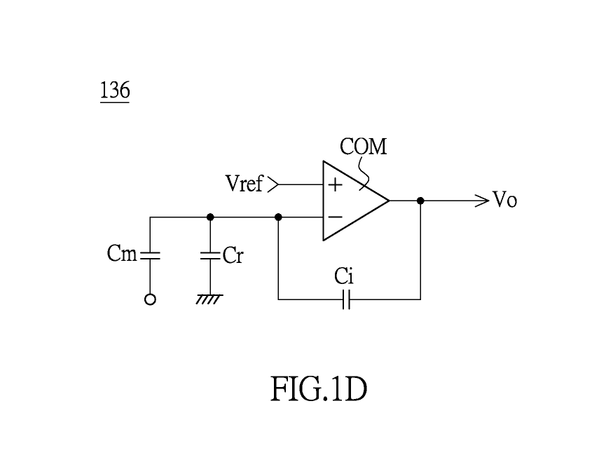

Firstly, please refer to FIGS. 1A and 1B, which respectively show an explosion diagram and a structural diagram of a machine tool according to an exemplary embodiment of the present disclosure.

As shown in FIGS. 1A and 1B, the machine tool 10 includes an operational element 110, a driving element 120, and a protective apparatus 130. The operational element 110 and the driving element 120 are configured on a machine table (as the machine table 140 shown in FIG. 1C). The operational element 110 can be a saw blade, a grinding wheel blade, a drill bit, or other type operational element. The driving element 120 can be a motor or other driving element which can work the operational element 110. The present disclosure is not limited thereto. In the present disclosure, the operational element 110 is a saw blade, and the driving element 120 is a motor. Therefore, as shown in FIG. 1C, the user can use the machine tool 10 to work the saw blade through driving the motor, and accordingly cut an object to be sawed 700 (e.g., wood) on the machine table 140, so that the object to be sawed 700 is cut to a suitable shape.

The protective apparatus 130 includes an insulating unit 132, a conducting unit 134, a capacitance sensor 136, and a control unit 138. The insulating unit 132 is configured between the operational element 110 and the driving element 120, then the driving element 120 drives the operational element 110 through the insulating unit 132. This means that the driving element 120 operates to work the insulating unit 132 and the operational element 110. For example, the driving element 120 is a motor and the operational element 110 is a saw blade. The saw blade and the insulating unit 132 are configured on a drive shaft of the motor. The insulating unit 132 is configured between the drive shaft and the saw blade, so that the drive shaft is insulated from the saw blade. At this point, the operation of the drive shaft can work the insulating unit 132 and the saw blade.

The conducting unit 134 contacts the operational element 110. In the present disclosure, the conducting unit 134 is a bearing and sleeves around the insulating unit 132. The conducting unit 134 has a holding portion 134a and a linking portion 134b configured to the holding portion 134a. The linking portion 134b contacts the operational element 110. The holding portion 134a electrically connects to the capacitance sensor 136. The linking portion 134b of the conducting unit 134 is fixed to the insulating unit 132, so that the insulating unit 132 is configured between the conducting unit 134 and the driving element 120, to cause the conducting unit 134 to be insulated from the driving element 120. Therefore, when the driving element 120 operates to work the insulating unit 132, the linking portion 134b, and the operational element 110, the holding portion 134a of the conducting unit 134 is immobile. In other disclosures, the conducting unit 134 is, for example, a ball bearing and sleeves around the insulating unit 132. When the driving element 120 operates to rotate the linking portion 134b of the ball bearing, the holding portion 134a of the ball bearing is immobile.

In the present disclosure, the insulating unit 132 has a concave portion 133 and the concave portion 133 has a positioning end 133a. In addition, the conducting unit 134 has a through-hole 134c corresponding to the shape of the concave portion 133, and the operational element 110 has a through-hole 112 corresponding to the shape of the concave portion 133. Therefore, the concave portion 133 of the insulating unit 132 can be configured through the through-hole 134c of the conducting unit 134 and the through-hole 112 of the operational element 110, so that the conducting unit 134 and the operational element 110 align the positioning end 133a of the concave portion 133. Therefore, the linking portion 134b of the conducting unit 134 and the operational element 110 can be fixed to the concave portion 133 of the insulating unit 132. The linking portion 134b of the conducting unit 134 electrically connected to the operational element 110 does not fall off from the insulating unit 132 easily.

The capacitance sensor 136 electrically connects to the conducting unit 134 to sense the capacitance of the conducting unit 134. The control unit 138 electrically connects between the capacitance sensor 136 and the driving element 120. At present, because the capacitance sensor 136 electrically connects to the operational element 110 through the conducting unit 134, the capacitance sensor 136 can detect the capacitance of the conducting unit 134 to determine whether an electric conductor approaches the operational element. This means that when the electric conductor (e.g., the user's hand) gradually approaches the operational element 110, the capacitance of the conducting unit 134 increases gradually. Next, the capacitance sensor 136 determines whether the capacitance is more than a predefined value. When the capacitance sensor 136 determines that the capacitance is more than the predefined value, the distance between the electric conductor (e.g., the user's hand) and the operational element 110 is too close. At this time, the capacitance sensor 136 generates a stop signal to the control unit 138. Then the control unit 138 controls the driving element 120 to stop driving the operational element 120 according to the stop signal, so that the insulating unit 132, the linking portion 134b, and the operational element 110 stop work.

Accordingly, the capacitance of the conducting unit 134 easily suffers from the interference of external conductors, e.g., the driving element 120 of the present disclosure, the motor, or etc. Therefore, the insulating unit 132 is configured between the operational element 110 and the driving element 120, and the conducting unit 134 is configured to the insulating unit 132. Therefore, the insulating unit 132 separates the driving element 120, so that the conducting unit 134 is insulated from the driving element 120 and the operational element 110 is insulated from the driving element 120, to avoid the electric power property of the driving element 120 in operation affecting the inducing capacitance between the operational element 110 and the conducting unit 134. Therefore, the capacitance sensor 136 can detect the more accurate capacitance.

Next, the control unit 138 turns off the switch of the driving element 120 according to the stop signal, to stop the operation of the driving element 120. Then when the capacitance sensor 136 determines that the capacitance of the conducting unit 134 is less than or equally to the predefined value, the control unit 138 restarts the driving element 120, to re-operate the switch of the driving element 120. In the present disclosure, the control unit 138 may be wired or wirelessly connect to the driving element 120 in a direct or indirect manner, and the present embodiment is not limited thereto.

In addition, in the present disclosure, the circuit structure of the capacitance sensor 136 can be implemented by an integrator. As shown in FIG. 1D, the capacitance sensor 136 includes a comparator COM and a feedback capacitance Ci. The positive input end (+) of the comparator COM receives a reference voltage Vref indicating the predefined value. The feedback capacitance Ci is connected between the negative input end (−) and the output end of the comparator COM. Furthermore, the negative input end (−) of the comparator COM receives the equivalent capacitance Cr and the mutual capacitance Cm. An end of the equivalent capacitance Cr electrically connects to the negative input end (−) of the comparator COM, and another end of the equivalent capacitance Cr connects to ground. An end of the mutual capacitance Cm electrically connects to the negative input end (−) of the comparator COM, and another end of the mutual capacitance Cm electrically connects to the operational element 110. The equivalent capacitance Cr and the mutual capacitance Cm are connected in parallel with each other.

Therefore, when the electric conductor (e.g., the user's hand) does not approach the operational element 110, the mutual capacitance Cm may sustain the fixed capacitance, and the negative input end (−) of the comparator COM receives the fixed value. When the electric conductor gradually approaches the operational element 110, the capacitance gradually increases. In addition, when the electric conductor gradually approaches the operational element 110 to a predefined distance, the received value of the negative input end (−) of the comparator COM is more than the reference voltage Vref, to generate an output signal Vo with low voltage level. This means that the capacitance sensor 136 determines that the capacitance is more than the predefined value, to generate the stop signal to the control unit 138. Next, the control unit 138 stops operating the driving element 120 according to the stop signal and then the linking portion 134b, the insulating unit 132, and the operational element 110 stop work, to avoid that the electric conductor (e.g., the user's hand) contacts the operational element 110 (e.g., the saw blade). The above circuit structure of the capacitance sensor 136 is described as an example, but another circuit structure of the capacitance sensor 136 may detect whether the distance between the electric conductor and the operational element 110 is too close. The present disclosure is not limited thereto.

In addition, because the operational element 110 has different sizes and types (e.g., the saw blade, the grinding wheel blade, or drill bit), the capacitance sensor 136 may sense different capacitance, causing the capacitance sensor 136 to determine inaccurate capacitance. For example, when the distance between the user's hand and the operational element 110 are too far, the capacitance sensor 136 still generates the stop signal to stop the operation of the driving element 120. Therefore, the capacitance sensor 136 further includes a capacitance adjusting unit (not shown in FIG. 1A). The capacitance adjusting unit is used for adjusting the predefined value, so that the capacitance sensor 136 can adjust the predefined value according to different sizes or types of the operational element 110, to determine the more accurate stop signal. More specifically, because the usage environment, the operational element 110, and the user are different, the capacitance sensor 136 can determine the sensing distance by adjusting the predefined value.

Therefore, as shown in FIG. 1C, when the user uses the operational element 110 to cut the object to be sawed 700 (e.g., wood) on the machine table 140 of the machine tool 10, the capacitance sensor 136 continuously determines whether the capacitance of the conducting unit 134 is more than the predefined value, to accordingly detect whether the user approaches the operational element 110. When the capacitance sensor 136 determines that the capacitance of the conducting unit 134 is more than the predefined value (i.e., the distance between the user and the operational element 110 is too close), the capacitance sensor 136 generates the stop signal to the control unit 138. The control unit 138 stops operating the driving element 120 according to the stop signal, and then the linking portion 134b, the insulating unit 132, and the operational element 110 stop work, to avoid the user contacting the operational element 110 and getting harmed.

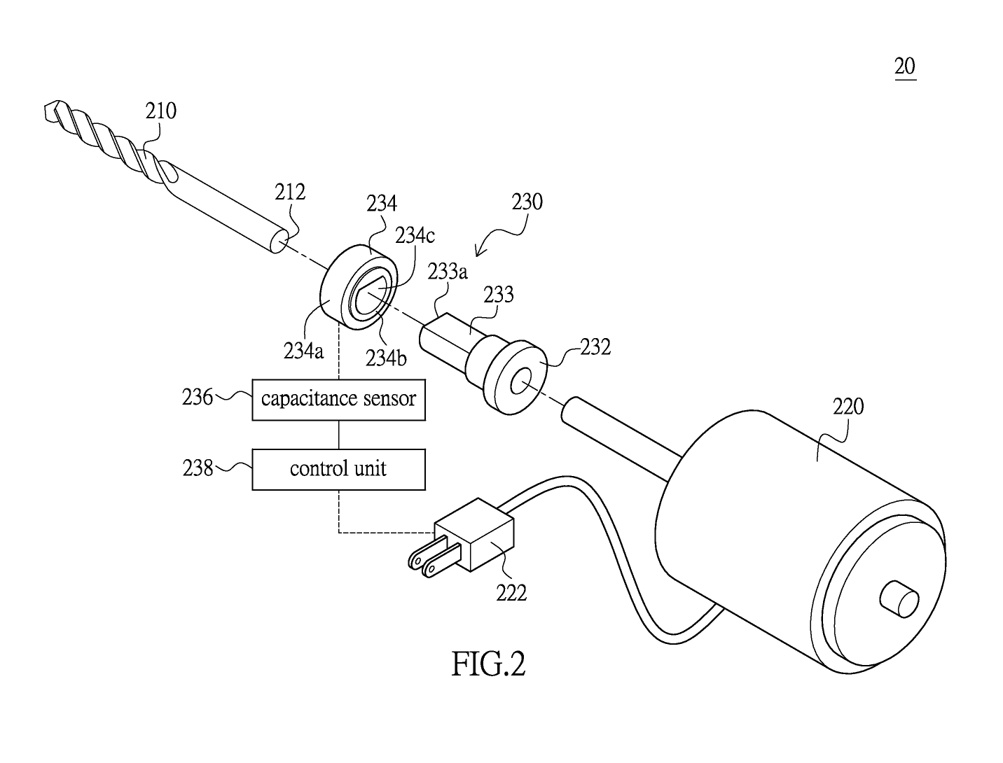

Next, please refer to FIG. 2, which shows an explosion diagram of a machine tool according to another exemplary embodiment of the present disclosure. As shown in FIG. 2, the machine tool 20 includes an operational element 210, a driving element 220, and a protective apparatus 230. The operational element 210 and the driving element 220 are configured on a machine table (not shown in FIG. 2). The operational element 210 can be a saw blade, a grinding wheel blade, a drill bit, or other type operational element. The driving element 220 can be a motor or other driving element which can work the operational element 210. The present disclosure is not limited thereto. In the present disclosure, the operational element 210 is a drill bit, and the driving element 220 is a motor.

The protective apparatus 230 includes an insulating unit 232, a conducting unit 234, a capacitance sensor 236, and a control unit 238. The insulating unit 232 is configured between the operational element 210 and the driving element 220. Then the driving element 220 drives the operational element 210 through the insulating unit 232. This means that the driving element 220 operates to work the insulating unit 232 and the operational element 210. For example, the driving element 220 is a motor and the operational element 210 is a drill bit. The drill bit and the insulating unit 232 are configured on a drive shaft of the motor. The insulating unit 232 is configured between the drive shaft and the drill bit, so that the drive shaft is insulated from the drill bit. At this time, the operation of the drive shaft can work the insulating unit 232 and the drill bit.

The conducting unit 234 contacts the operational element 210. In the present disclosure, the conducting unit 234 is a bearing and sleeves around the insulating unit 232. The conducting unit 234 has a holding portion 234a and a linking portion 234b configured to the holding portion 234a. The linking portion 234b contacts the operational element 210. The holding portion 234a electrically connects to the capacitance sensor 236. In addition, the linking portion 234b of the conducting unit 234 is fixed to the insulating unit 232, so that the insulating unit 232 is configured between the conducting unit 234 and the driving element 220, to cause the conducting unit 234 to be insulated from the driving element 220. Therefore, when the driving element 220 operates to work the insulating unit 232, the linking portion 234b, and the operational element 210, the holding portion 234a of the conducting unit 234 is immobile. In other disclosures, the conducting unit 234 is, for example, a ball bearing and sleeves around the insulating unit 232. When the driving element 220 operates to rotate the linking portion 234b of the ball bearing, the holding portion 234a of the ball bearing is immobile.

In the present disclosure, the insulating unit 232 has a concave portion 233 and the concave portion 233 has a positioning end 233a. In addition, the conducting unit 234 has a through-hole 234c corresponding to the shape of the concave portion 233. Therefore, the concave portion 233 of the insulating unit 232 can be configured through the through-hole 234c of the conducting unit 234, so that the through-hole 234c of the conducting unit 234 aligns the positioning end 233a of the concave portion 233. Therefore, the linking portion 234b of the conducting unit 234 can be fixed to the concave portion 233 of the insulating unit 232, and does not fall off from the insulating unit 232 easily. The end portion 212 of the operational element 210 can be inserted and fixed into the hole (not shown in FIG. 2) of the insulating unit 232, as the traditional method for fixing the drill bit, and further descriptions are hereby omitted. It is worth to note that although the end portion 212 of the operational element 210 is fixed into the hole of the insulating unit 232, the operational element 210 is insulated from the driving element 220, the conducting unit 234 is insulated from the driving element 220, and the operational element 210 electrically contacts the linking portion 234b of the conducting unit 234. Therefore, the above connection relationships and operations can avoid the electric power property of the driving element 220 in operation affecting the inducing capacitance between the operational element 210 and the conducting unit 234.

The capacitance sensor 236 electrically connects to the conducting unit 234 to sense the capacitance of the conducting unit 234. The control unit 238 electrically connects between the capacitance sensor 236 and the driving element 220. With respect to operation of the capacitance sensor 236 and the control unit 238, it is the same as that of the capacitance sensor 136 and the control unit 138, so a detailed description is omitted. The difference is that the control unit 238 directly turns off the power 222 of the driving element 220 according to the stop signal, to stop the operation of the driving element 220. Therefore, when the capacitance sensor 236 determines that the capacitance of the conducting unit 234 is more that the predefined value, this means that the distance between the electric conductor (e.g., the user's hand) and the operational element 210 is too close. Then the capacitance sensor 236 generates the stop signal to the control unit 238. The control unit 238 directly turns off the power 222 of the driving element 220 according to the stop signal to stop operating the driving element 220, so that the insulating unit 232, the linking portion 234b, and the operational element 110 stop work.

Accordingly, the present embodiment in FIG. 2 needs to additionally design the turn on/off operation of the power of the driving element 220. The foregoing embodiment in FIG. 1A needs to additionally design the turn on/off operation of the switch of the driving element 120. Because the internal structure of the driving element 120 shown in FIG. 1A is more complex than that of the power 222 in the present embodiment, the turn on/off operation configured in the power 222 is easier than the turn on/off operation configured in the driving element 120 shown in FIG. 1A.

In summary, for a protective apparatus and a machine tool of the present disclosure, a capacitance sensor and an operational element are electrically connected with each other, so that the capacitance sensor does not have the blind spot problem for the capacitance sensor configuring the different position of the operational element. Therefore, when the user uses a machine tool, the protective apparatus and the machine tool can reduce the probability of harm.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A protective apparatus, adapted for a machine tool, the machine tool having a driving element and an operational element, the driving element used for driving the operational element, and the protective apparatus comprising:
an insulating unit, configured between the operational element and the driving element, and the driving element driving the operational element through the insulating unit;
a conducting unit, contacting the operational element;
a capacitance sensor, electrically connected to the conducting unit and used for sensing a capacitance of the conducting unit; and
a control unit, electrically connected to the capacitance sensor and the driving element;
wherein, when the capacitance sensor determines that the capacitance is more than a predefined value, the capacitance sensor generates a stop signal to the control unit, and the control unit controls the driving element to stop driving the operational element according to the stop signal.

2. The protective apparatus according to claim 1, wherein the conducting unit is a bearing and sleeves around the insulating unit, the bearing has a holding portion and a linking portion configured to the holding portion, the linking portion contacts the operational element, and the holding portion electrically connects to the capacitance sensor.

3. The protective apparatus according to claim 2, wherein the linking portion of the bearing is fixed to the insulating unit and the insulating unit is configured between the bearing and the driving element, so that the bearing is insulated from the driving element.

4. The protective apparatus according to claim 1, wherein the driving element is a motor, the operational element is a saw blade, the saw blade and the insulating unit is configured to a drive shaft of the motor, and the insulating unit is configured between the drive shaft and the saw blade, so that the drive shaft is insulated from the saw blade.

5. The protective apparatus according to claim 1, wherein the driving element is a motor, the operational element is a drill bit, the drill bit and the insulating unit are configured to a drive shaft of the motor, and the insulating unit is configured between the drive shaft and the drill bit, so that the drive shaft is insulated from the drill bit.

6. The protective apparatus according to claim 1, wherein the capacitance sensor comprises a capacitance adjusting unit configured for adjusting the predefined value.

7. The protective apparatus according to claim 1, wherein when the capacitance sensor determines that the capacitance is more than the predefined value, the control unit closes a power of the driving element to stop the operation of the driving element according to the stop signal.

8. A machine tool, comprising:
an operational element, configured to a machine table;
a driving element, configured to the machine table; and
a protective apparatus, comprising:
an insulating unit, configured between the operational element and the driving element, and the driving element driving the operational element through the insulating unit;
a conducting unit, contacting the operational element;
a capacitance sensor, electrically connected to the conducting unit and used for sensing a capacitance of the conducting unit; and
a control unit, electrically connected to the capacitance sensor and the driving element;
wherein, when the capacitance sensor determines that the capacitance is more than a predefined value, the capacitance sensor generates a stop signal to the control unit, and the control unit controls the driving element to stop driving the operational element according to the stop signal.

9. The protective apparatus according to claim 8, wherein the driving element is a motor, the operational element is a saw blade, the saw blade and the insulating unit is configured to a drive shaft of the motor, and the insulating unit is configured between the drive shaft and the saw blade, so that the drive shaft is insulated from the saw blade.

10. The protective apparatus according to claim 8, wherein the driving element is a motor, the operational element is a drill bit, the drill bit and the insulating unit are configured to a drive shaft of the motor, and the insulating unit is configured between the drive shaft and the drill bit, so that the drive shaft is insulated from the drill bit.
